(19) United States
(12) Patent Application Publication
(10) Pub. No.: US 2008/0263841 A1
(43) Pub. Date: Oct. 30, 2008

(54) Method for Production of Expanded Material and Cutting Device for the Same

(76) Inventor: Kurt Thomas Stelzl, Wien (AT)

Correspondence Address: YOUNG & THOMPSON, 209 Madison Street, Suite 500, ALEXANDRIA, VA, 22314, US

(21) Appl. No.: 11/663,988

(22) PCT Filed: Sep. 30, 2005
(86) PCT No.: PCT/AT05/00392

§ 371 Date: Mar. 25, 2008

(30) Foreign Application Priority Data
Sep. 30, 2004 (AT) A 1633/2004

(51) Int. Cl. B21D 31/04; B23K 15/08; B23K 26/38

(52) U.S. Cl. 29/6.1; 219/121.18; 219/121.67

(57) ABSTRACT

In the production of expanded material from a sheet material strip (4), in particular, a metal strip, cuts (2) are introduced into the material strip (4), by way of at least one cutting unit (5), using laser, water or electron streams, whereupon the material strip (4) is subjected to a drawing by way of a drawing device (28). The cuts in the material strip (4) are introduced by running the cutting unit (5), perpendicular to the longitudinal or transport direction (7) of the material strip, in the form of perpendicular cuts (2), along perpendicular lines (3), perpendicular to the longitudinal or transport direction (7).

The invention relates to a process for producing expanded material from a foil-like material strip and a cutting means for foil-like material strip, for producing expanded material, according to the introductory parts of the independent claims.

By the expansion of material lengths which have been provided beforehand with cuts, net or composite honeycomb structures can be obtained which have a large surface, and which are used especially as explosion-proof material, but also as weather barrier, heat exchanger, flame barrier, filter, insulator, spacer, catalyst. Besides metal, such as especially aluminum, high-grade steel or precious metal, also ceramic, plastic, rubber, coated paper, etc. can be used as the material. The thickness of the strips material can be for example between 25 μm and 90 μm.

In particular, to reduce the danger of explosion in a propellant tank and/or gas tank (liquefied gas tanks) use of a metallic expanded material provided with cuts has become known, its being used such that it is delivered in the form of bales or compressed round bodies in tanks or the like, causing a significant enlargement of the surface there, but occupying only a small proportion of the tank volume. The material here was originally aluminum or an aluminum alloy, since in the strip the cuts were made using blade rolls (compare EP 340 619 B), the hardness of the blades having limited the choice of material. In cutting with blade rolls however chips and abrasion particles are formed which are disadvantages in the respective application of the expanded material. Mainly in the case of using the expanded material as an explosion-proof material in fuel tanks these particles end up in the fuel and with it in filter systems of internal combustion engines or in the machines themselves, where they cause damage.

To remedy this situation, EP 912 267 B has already suggested making cuts in the material lengths using cutting units which deliver laser beams, water jets, or electron beams, several of these cutting units being arranged stationary next to one another transversely to the direction in which the strip runs, so that in the strip which moves past underneath intermittent lengthwise cuts are made next to one another, and accordingly there are as many lengthwise lines next to one another as cutting units. In this technology no chips or similar particles are formed during cutting, nor are any lubricants necessary as in the case of blade rolls so that clean expanded materials can be obtained. The length of the lengthwise cuts can be easily set by turning the cutting units and cutting jets or beams on and off. But only lengthwise cuts are made, i.e. cuts extending in the running or lengthwise direction of the material strip, and if a foil length is to be cut transversely to the lengthwise direction, this must be done in the course of pretreatment which is not detailed. For any line according to which cuts are made in the strip, its own cutting jet or beam and thus its own cutting unit within the framework of the cutting means are necessary so that the hardware cost is relatively great. Finally it is a serious disadvantage that the expansion of the material strip provided with lengthwise cuts must take place by pulling the strip apart in the direction of width, spreading of the strip and at the same time a shortening of the strip in the running direction being caused. Pulling apart transversely to the lengthwise direction of the strip however can only be done with relatively complex edge-side gripping means for the strip, their own conveyor chains or toothed belt sections being necessary, as is described also in the indicated EP 912 287 B.

The object of the invention is to suggest an alternative technique for cutting of material strips and production of expanded material, a comparatively low hardware cost being necessary, and the expansion of the strip to be carried out after cutting of the material strip can be carried out especially easily and with extremely simple means.

To achieve this object the invention calls for a process for producing expanded material and a cutting means for foil-like material lengths, especially metal strips, for producing expanded material, as defined in the attached independent claims. Advantageous embodiments and developments are given in the dependent claims.

As claimed in the invention, cuts are thus made in the material strip, especially a foil-like metal strip which consists preferably of high-grade steel, optionally also aluminum or an aluminum alloy, as transverse cuts, a cutting jet or beam being moved along a transverse line relative to the material strip and being turned on and off in doing so, so that transverse cuts are formed which are spaced apart from one another, i.e. separated from one another by material, in order to achieve the desired net configuration after expansion. In this case the transverse cuts are made offset to one another in successive transverse lines preferably with respect to the desired net configuration. By the length of turning on and off during the movement of the cutting unit transversely to the material strip which takes place preferably with essentially a uniform speed, the spacing of the cut to the material in each transverse line can be fixed, depending on the speed of the transverse motion of the cutting unit. Although, especially for wider material strips, it is quite conceivable to use two or even more cutting units which each cover part of the width of the material strip, in order to be able to cut crosswise more quickly by parallel operation with the cutting units, for reasons of construction as simple as possible, it is preferable to provide only a single cutting unit which is moved over the entire width of the material length. This is sufficient for example in the production of expanded material from metal foils for producing explosion-proof material, since for these applications the metal strip generally has a width on the order of roughly 300 mm; this amount then corresponds to the respective stroke of the cutting unit in cutting transversely, and the time for this can be relatively short—for a correspondingly fast transverse movement in order to achieve such adequate advance in transverse cutting of the metal strips. The cuts are routed preferably as far as the respective lengthwise edge of the material strip, on both sides of it, in this technique, differently than in the known technique, where intact edges are necessary for expansion in the transverse direction, since for the expansion which is now possible only in the lengthwise direction of the strip material it is not necessary to grasp the lengthwise edges of the strip; in this way, an improved, uniform network structure can also be achieved over the entire width of the material strip during expansion. It is thus an important advantage in this technology that on the one hand simple expansion only in the lengthwise direction, especially by guiding the material path after cutting transversely via roughing rolls which turn with increasingly higher rpm is possible, and that on the other hand the grip edges necessary in the existing expansion techniques can be superfluous so that the expanded structure can also be uniformly maintained in the edge regions.

It is inherently conceivable in a correspondingly fast transverse movement to make transverse cuts in the material length, while it is being transported continuously in the lengthwise direction. The transverse cuts would then not run exactly at a right angle to the lengthwise direction of the material strip, but have an angle to the lengthwise direction diverging somewhat from 90°, for example by 5° or 10°. This would be quite practicable especially for comparatively narrow material strips. But to enable a high quality and also narrow mesh network structure of the expanded material, an arrangement of the transverse cuts as exactly as possible at a right angle to the lengthwise direction of the material strip is advantageous, and for this purpose advantageously the driving of the material strip during the transverse cutting process is stopped each time, i.e. the material length is transported forward intermittently and stopped while the transverse cuts are being made, according to one transverse line at a time; after the transverse cuts are made according to one line over the width of the strip the material strip is then further transported by the distance between the transverse lines, with which the transverse cuts are made, and this distance can be for example a few mm, roughly 2-10 mm.

This technique can be used especially advantageously to produce explosion-proof material for plastic containers, then preferably the material strip consisting of a high-grade steel foil.

With respect to the fact that the transverse cuts in the material length can also be used as transport and alignment perforations, and that the expansion process should generally be able to be carried out independently of the cutting process, it can also be advantageously provided that the material length after transverse cutting is rolled into a coil and afterwards is expanded as the coil is unwound by guidance over roughing rolls driven with different rpm. In this way, the expansion process which can generally be carried out with a higher speed than the cutting process can be implemented, without adverse effects, by the preferred intermittent operating mode when the material length is cut transversely.

Because in this technology the material lengths are expanded preferably only in the lengthwise direction, when the material length is wound up the holes formed by the transverse cuts come to rest on one another; this can be useful as alignment and transport control. But, depending on the material, it can arise that the net lengths in the wound roll lie relatively tightly on top of one another; this is advantageous for support, but can be disadvantageous for the treatment of the expanded material, for example for an explosion-proof material. In order to enable an especially “airy” expanded material with respect to network bales with an especially large surface, with especially large dimensions, at low density and mass, it has also proven advantageous if two expanded material lengths provided with transverse cuts, of which one is turned relative to the other by 180°, are wound into a two-ply expanded material.

The driving means for the cutting unit in order to move it transversely to the material length can be implemented with conventional techniques, such as for example with a drive spindle and a spindle nut which is held rotationally strong and which is coupled to the cutting unit. But to enable especially high speeds in the transverse motion of the cutting unit, as much as possible without friction losses, the driving means, instead of being mechanically executed as described above, can contain a known electromagnetic linear drive.

Preferably there is cutting of the material strip with laser beams, and the laser radiation is then advantageously directed by the means which produces the laser radiation, i.e. a laser generator, via stationary deflection mirrors in the transverse direction to the cutting unit which can be moved crosswise, and is deflected there in the direction to the material strip.

The invention is explained below using especially preferred embodiments, to which it is however not limited, with reference to the drawings.

The drawings show in particular:

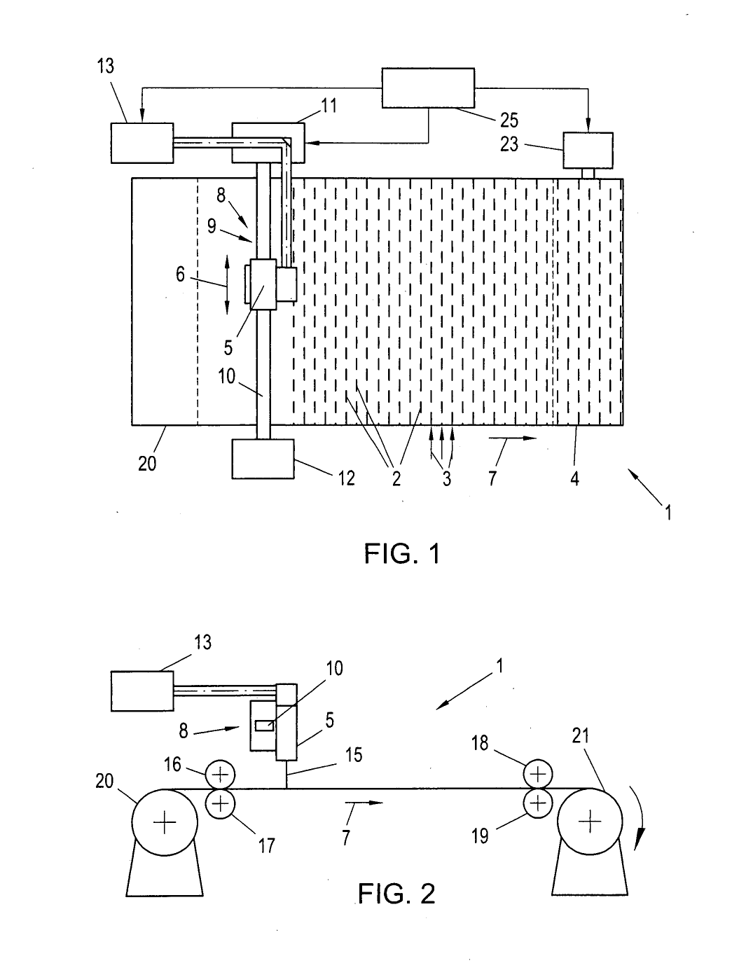

FIG. 1 shows a schematic top view of the cutting means for transverse cutting of a foil-like material strip;

FIG. 2 shows a schematic of such a cutting means including a transport means of the material strip;

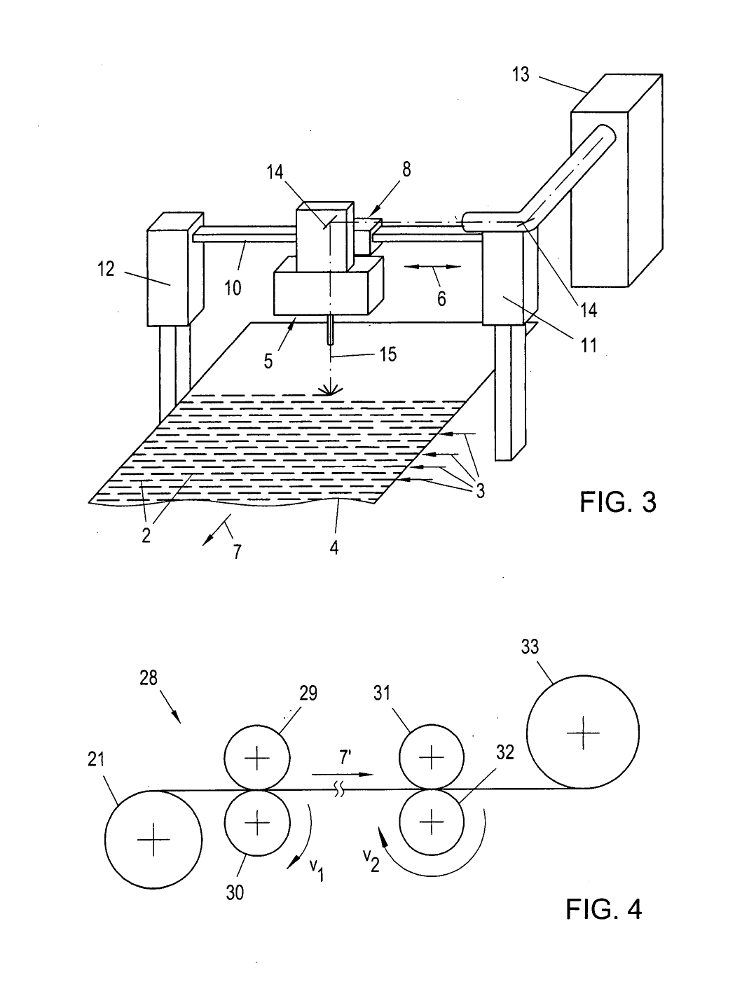

FIG. 3 shows a diagrammatic partial view of a cutting means together with a part of a material strip which has been cut straight;

FIG. 4 shows entirely schematically an arrangement for expanding a material strip which has been cut with a cutting means as shown in FIGS. 1 to 3;

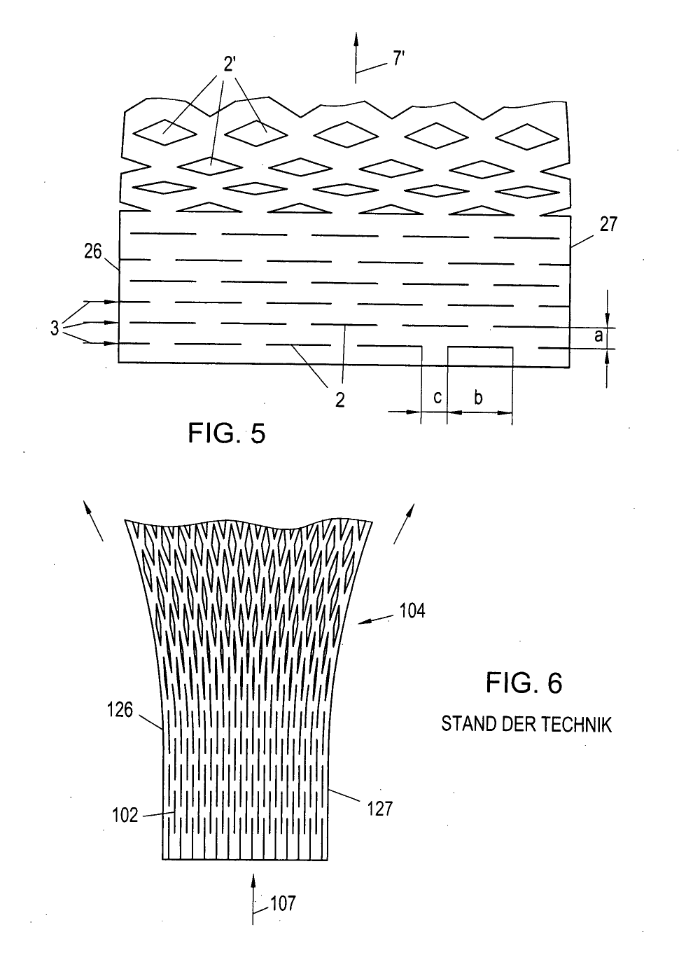

FIG. 5 shows the process for this lengthwise expansion in a schematic top view of one part of a material strip;

FIG. 6 shows in a comparable top view an expansion process for a material strip provided with lengthwise cuts, according to the prior art; and

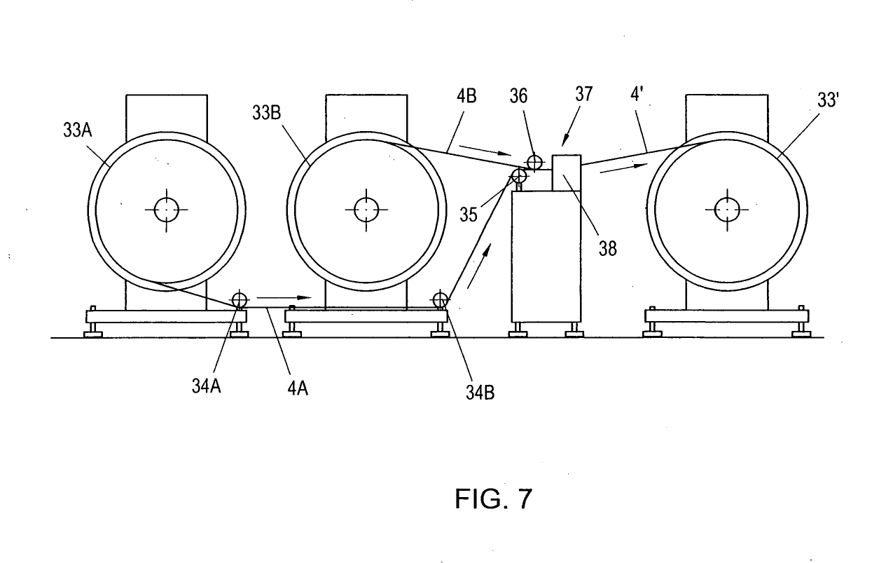

FIG. 7 schematically shows an arrangement for winding up two material strips with orientations which are different relative to one another, into a two-ply expanded material bale.

The cutting means 1 shown schematically in a top view and a side view in FIGS. 1 and 2 and diagrammatically in FIG. 3 (in FIGS. 1 to 3 the individual parts have been omitted for purposes of clarity) for making spaced transverse cuts 2 along transverse lines 3 in a material strip 4 has a cutting unit 5 which can be moved as shown by the double arrow 6 transversely to the transport direction 7 of the material strip 4. For this purpose the cutting means 5 is assigned a driving means 8 which for example has a drive spindle together with the pertinent electric motor and transmission or preferably an electromagnetic linear drive 9 in the manner of a “magnetic levitation strip”, with magnets which are not detailed in the drawing and which are located along a rail 10. On the ends of the rail 10 there are carriers 11, 12 (omitted in FIG. 2), compare besides FIG. 1 also FIG. 3 in which the components for power supply for the electromagnetic linear drive 9 are located.

The cutting unit 5 is made for example as a laser beam cutting unit with the corresponding optical means which are not detailed (such as focussing optics), laser radiation being produced by a laser generator 13 and being pointed at the material strip 4 via deflection mirrors 14. FIGS. 2 and 3 show the laser beam 15 used for cutting. The laser radiation can be shielded at least partially between the laser generator 13 and the cutting head 5 for safety reasons, compare also the pipeline shown in FIG. 3.

The material strip 4 runs for example over a table or as shown in FIG. 2 through pairs of guide rolls 16, 17 and 18, 19, and it is wound up by a roll 20, and the material strip 4 which has been cut crosswise is wound onto a roll 21. The roll 21 is for example driven by an electric motor 23 with a connected transmission, as is shown in FIG. 1.

FIG. 1 finally shows another control means 25 which has been omitted in the other figures and which correspondingly triggers the laser beam generating means, i.e. the laser generator 13, furthermore the driving means 8 for the cutting unit 5 and also the motor 23 for the roll 21, for advance of the material strip 4. In particular the material strip is driven intermittently and is transported forward each time by a distance a between two transverse cuts-transverse lines 3 (compare also FIG. 5), after which the cutting unit 5 in the transverse direction is moved over the material strip from one lengthwise edge 26 to the other lengthwise edge 27; during this transverse motion of the cutting unit 5 the laser beam 16 is turned on and off intermittently in order to produce transverse cuts 2 in the material strip 4 with a length b and a mutual distance c (see FIG. 5). The transverse cuts 2, as is apparent from the drawings, are offset against one another from transverse line 3 to transverse line 3, the transverse cuts 2 in the 1st, 3rd, 5th etc. transverse line on the one hand and in the 2nd, 4th, 6th etc. transverse line on the other being aligned to one another. Furthermore the transverse cuts 2 also extend as far as the lengthwise edges 26, 27 of the material strip.

The material strip 4 which is provided with transverse cuts 2 as is apparent from FIGS. 1 to 3, and which has been rolled into a coil 21 can be drawn with a simple expansion means 28, as is shown quite schematically in FIG. 4, by expansion simply in the lengthwise direction of the material strip 4 into the desired expanded material. In doing so the material strip 4 which has been cut crosswise is unwound from the roll or coil 21 and is routed between two pairs of roughing rollers 29, 30 and 31, 32, and finally rewound into a coil 33. The front roughing rolls 29, 30 turn with a lower peripheral speed v1 than the second roughing rolls 31, 32 with a peripheral velocity v2 which is much greater, so that the strip 4 with advance in the direction 7′ according to length is expanded to the degree given by the speed difference.

The drives for the individual roughing rolls 29-32 or for the rolls, for example 33, are conventional and are not detailed in the drawings. Different peripheral speeds v1, v2 can be reached by the different diameters of the roughing rolls 29, 30 and 31, 32 and/or by their different rpm.

In this expansion of the material length 4 in the lengthwise direction 7′ the transverse cuts 2 are enlarged in the lengthwise direction, compare FIG. 5, so that roughly rhomboidal openings 2′ are formed, the material strip 4 being narrowed in its width somewhat, for example to roughly 95% of the original width. When the material length 4 is rolled up the holes 2 and 2′ in the coil lie congruently on top of one another.

FIG. 6, in a comparison to simple lengthwise expansion according to FIG. 5, shows an expansion process of a material length 104 which has been provided as in the prior art with cuts 102 in the lengthwise direction (i.e. in the transport direction) 107 of the material strip 104. Here the lengthwise edges 126, 127 of the material length 104 are continuous, i.e. without cuts, and these lengthwise edges 126, 127 are grasped with gripping means which are not further shown in FIG. 6 and are pulled apart from one another, as is illustrated schematically by arrows in FIG. 6. This yields a comparatively high hardware cost for expansion, aside from the fact that the lengthwise edges 126, 127 which have not been cut through and which must be intact for gripping using gripping means, lead to a comparatively less homogenous expansion result.

In practical tests, a metal strip of high-grade steel with a thickness in the range of roughly 50 μm and with a width of 300 mm was provided with transverse cuts, with a length b which was roughly 15 mm and with a distance c from one another in the transverse direction of roughly 2 mm. The distance of the transverse cuts-transverse lines, labelled a in FIG. 5, was likewise roughly 2 mm. After simple lengthwise expansion an expanded material was obtained which could be easily formed into bulge-shaped bodies which were intended as explosion protection for fuel tanks, and for this purpose were placed in fuel tanks.

It has already been pointed out above that when the material strip 4 is rolled up, the holes 2 and 2′ can lie congruently on top of one another in the coil (compare the roll 33 in FIG. 4). In this way the material strip 4 can be especially tight in the coil 33; this can be favorable on the one hand for supporting the coil with respect to the lower space requirement; this however can be desirable for further processing since the compaction which increases the weight also stresses the material and can pose problems in the forming of network structures, such as for example spherical or cylindrical bales as explosion-proofing material. FIG. 7 schematically shows an arrangement in the form of a “fabrication module”, two material strips 4A, 4B being unwound from two rolls 33A, 33B and being wound into two-ply expanded material 4′, into a roll 33′. Here it is important that the two material strips 4A, 4B are placed on top of one another aligned oppositely, so that their holes 2′ (see FIG. 5) cannot “slip into one another”, by which the two-ply expanded material 4′ becomes especially loose or “airy”. It is thus important here that one material strip, for example 4B, compared to the other material strip, for example 4A, is turned by 180°, therefore turned with the top to the bottom.

FIG. 7 furthermore shows that the two material strips 4A, 4B after unwinding from the coils 33A, 33B run over guide rolls 34A, 34B and farther, with guidance using rolls 35, 36 over a control table 37, where there is an electronic control unit 38 to which signals are supplied from diameter sensors, with which the different roll diameters are detected, and also the diameter of the take-up coil 33′ can be preset. When the desired diameter of the coil 33′ is reached the feed of the material strips 4A, 4B can be stopped via the control unit 38, the material strips 4A, 4B are cut off, and the coil 33′ with the two-ply expanded material can be removed, after which a new, empty reel for winding up the other two-ply expanded material can be attached.

The diameter sensors are not detailed in the drawings and can be present in a conventional construction, for example in the form of ultrasonic sensors or photoelectric barriers.

With the two-ply expanded material an especially loose arrangement of the final network bale material is achieved, large outside dimensions or surfaces at low mass being achieved, so that this material is especially well suited for explosion-proofing material in the fuel tanks, especially also in reserve canisters.

1. Process for producing expanded material from a foil-like material strip (4), in which in the material strip using at least one cutting unit (5) cuts are made by laser beams, water jets, or electron beams, after which the material strip is subjected to expansion using an expansion means (28), characterized in that the cuts are made in the material strip (4) with guidance of the cutting unit (5) transversely to the lengthwise or transport direction of the material strip as transverse cuts (2) according to transverse lines (3) transversely to the lengthwise or transport direction of the material strip (4).

2. Process as claimed in claim 1, wherein the transverse cuts (2) extend as far as the lengthwise edges (26, 27) of the material strip (4).

3. Process as claimed in claim 1, wherein the transverse cuts (2) are made offset to one another from transverse lines (3) which follow one another.

4. Process as claimed in claim 1, wherein the material strip (4) is transported intermittently forward and is stopped while the transverse cuts (2) are being made in one transverse line (3) at a time.

5. Process as claimed in claim 1, wherein the material strip (4) provided with the transverse cuts (2) is expanded only in the lengthwise direction (7′).

6. Process as claimed in claim 5, wherein the material strip (4) after transverse cutting is rolled into a coil (21) and afterwards is expanded as it is unwound from the coil (21) by guidance over roughing rolls (29, 30, 31, 32) which are driven with different rpm.

7. Process as claimed in claim 5, wherein two expanded material strips (4A, 4B) which are provided with transverse cuts, of which one is turned relative to the other by 180°, are wound up into a two-ply expanded material (4′).

8. Process as claimed in claim 1, wherein the transverse cuts (2) are made in a metal strip (4).

9. Process as claimed in claim 1, wherein the material strip (4) is a high-grade steel strip.

10. Cutting means (1) for foil-like material strips (4), for producing expanded material, the cutting means containing at least one cutting unit (5) which delivers laser beams, water jets, or electron beams and which is controlled by a control means (25), wherein the cutting unit (5) can be moved transversely to the lengthwise or transport direction (7) of the material strip (4) using driving means (8), and the beam or jet delivery can be turned on and off during this transverse motion by the control means (25).

11. Cutting means as claimed in claim 10, wherein the driving means (8) contain an electromagnetic linear drive (9).

12. Cutting means as claimed in claim 10, wherein the cutting unit (5) which delivers the laser beams is supplied via fixed deflection mirrors (14, 15) from a means (13) which produces laser radiation.

13. Process as claimed in claim 2, wherein the transverse cuts (2) are made offset to one another from transverse lines (3) which follow one another.

14. Process as claimed in claim 2, wherein the material strip (4) is transported intermittently forward and is stopped while the transverse cuts (2) are being made in one transverse line (3) at a time.

15. Process as claimed in claim 3, wherein the material strip (4) is transported intermittently forward and is stopped while the transverse cuts (2) are being made in one transverse line (3) at a time.

16. Process as claimed in claim 2, wherein the material strip (4) provided with the transverse cuts (2) is expanded only in the lengthwise direction (7′).

17. Process as claimed in claim 3, wherein the material strip (4) provided with the transverse cuts (2) is expanded only in the lengthwise direction (7′).

18. Process as claimed in claim 4, wherein the material strip (4) provided with the transverse cuts (2) is expanded only in the lengthwise direction (7′).

19. Process as claimed in claim 6, wherein two expanded material strips (4A, 4B) which are provided with transverse cuts, of which one is turned relative to the other by 180°, are wound up into a two-ply expanded material (4′).

20. Process as claimed in claim 2, wherein the transverse cuts (2) are made in a metal strip (4).
